(19) United States
(12) Patent Application Publication
(10) Pub. No.: US 2009/0007068 A1
(43) Pub. Date: Jan. 1, 2009

(54) Accessing Non-Public Code

(75) Inventors: Joseph Rohde, Redmond, WA (US); Boris Vidolov, Redmond, WA (US); Dominic Hopton, Redmond, WA (US); Ryan Vogrinec, Duvall, WA (US); Lexin Shan, Oakland, CA (US); Naysan Naderi, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/768,951

(22) Filed: Jun. 27, 2007

(51) Int. Cl. G06F 9/44

(52) U.S. Cl. 717/120

(57) ABSTRACT

Non-public software constructs within a portion of code may be made accessible by analyzing the code, locating non-public items such as classes, objects, data structures, methods, interfaces, arrays, and other items, and creating a public call for the item in an executable code. In some instances, a call may reference one or more non-public items and such a call may be a static call created at the same time as the function, or may be a dynamically created at runtime. The calls may handle non-public arrays within calls, generic calls, as well as calls using a non-public interface.

### BACKGROUND

Some data, data structures, methods, interfaces, and other portions of programming code may be defined as non-public. When an item is defined as non-public, it is generally not shared outside of the portion of code for which it is assigned. Non-public items are very useful for manipulating data and performing analysis without interfering with public data that may be shared across various portions of code. In some cases, such as testing a portion of code or for other reasons, access may be desired for non-public items.

### SUMMARY

Non-public items within a portion of code may be made accessible by analyzing the code, locating non-public software constructs such as classes, objects, data structures, methods, interfaces, arrays, and other items, and creating a public call for the item in an executable code. In some instances, a call may reference one or more non-public items and such a call may be a static call created at the same time as the function, or may be a dynamically created at runtime. The calls may handle non-public arrays within calls, generic calls, as well as calls using a non-public interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system for accessing private or non-public items.

FIG. 2 is a flowchart illustration of an embodiment showing a method for creating accessor code.

FIG. 3 is a flowchart illustration of an embodiment showing a method for generating a dynamic call.

### DETAILED DESCRIPTION

Non-public classes, variables, methods, and other software constructs or items within a set of executable computer code are made available by analyzing the executable code and creating a second executable code that creates a public version of the non-public items. The second executable code may have direct calls into the executable code as well as functions or other executable code that may be used to create appropriate calls to the first executable code.

The public versions of the non-public software constructs may be used for many purposes, including testing the internal workings of the executable code as well as reverse engineering the code. The public versions of non-public items may include static calls directly into the various non-public items as well as dynamic calls that are created ‘on the fly’ for calls that include generic items. In complex calls, multiple layers of non-public and public calls may be recursively created to access a specific non-public class or other item. Some items, such as interfaces, may have public versions of additional items that are created to ensure that the interface properties may mimic the properties of a non-public interface.

The executable code may be any type of code, including code written in procedural or object oriented languages. While each language may have different subtleties and nuances, the basic concepts may be applied to any programming language. For the purposes of this specification, those concepts and labels from one genre of programming languages may be substituted for a corresponding concept or label in another genre.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

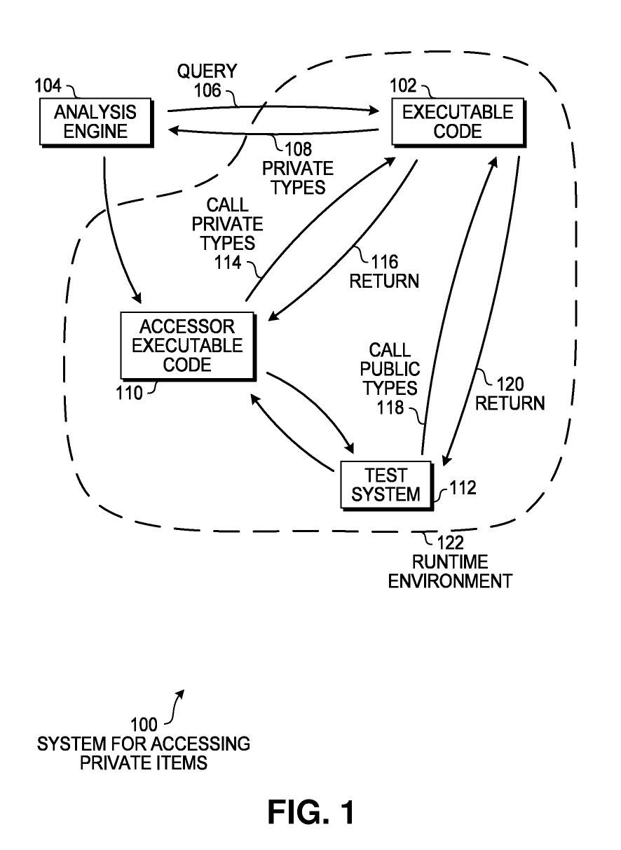

FIG. 1 is a diagram of an embodiment 100 showing a system for accessing private or non-public items. Embodiment 100 illustrates one use for a mechanism for analyzing a section of executable code 102, identifying non-public software constructs such as classes, objects, interfaces, variables, functions, methods, or other items and creating a special accessor executable code 110 that may include public items that may call the non-public items in the executable code 102.

Embodiment 100 and other examples in this specification may refer to testing the executable code 102. In some cases, the executable code 102 may be referred to as code under test. Embodiment 100 may be used for many other purposes other than testing. For example, embodiment 100 may be used for reverse engineering the executable code 102 or for accessing undocumented features for maintenance purposes or enhancing the functions of the executable code 102. Throughout this specification, any reference to testing is for example and is not to be construed as limiting in any fashion.

The executable code 102 may be any type of executable instructions that may be executed by any type of processor. In some cases, the executable code 102 may be a binary executable that may be executed within an operating system or runtime environment on a general purpose processor. In other cases, the executable code 102 may be run directly on a dedicated processor. In many cases, such code may be stored in a read only memory, flash device, or other device. The executable code 102 may be operated using a simulator or other development and debugging device prior to storing the code in such a device. In some cases, the executable code 102 may be tested in a software simulator and, after debugging, stored in a gate array, very large scale integration (VLSI) circuit, application specific integrated circuit (ASIC), or other hardware device.

The executable code 102 may be intermediate code, sometimes referred to as bytecode, which may be executed on a virtualized runtime environment, such as a virtual machine using a runtime compiler or an interpreter. In other cases, the executable code 102 may be compiled code that may be executed directly on a processor with or without an operating system. The executable code 102 may be any type of executable instructions that may be used by a processor or converted into executable logic.

An analysis engine 104 may analyze the executable code 102 by performing queries 106 which may return non-public types 108 or other non-public items. Non-public types or software constructs may be classes, variables, functions, methods, interfaces, objects, data structures, components, or any other items within the executable code 102 that are not shared outside the code.

In some cases, non-public software constructs may be internal items that are used within the executable code 102 for processing data or performing various functions. In many cases, the executable code 102 may have public access points for calling functions within the executable code 102. Within the functions or operations of the public access points, various non-public items may be defined to perform the internal operations or logic of the public function. Non-public classes, variables, or other items may occupy less processing overhead.

non-public non-public The analysis engine 104 may use various techniques for performing a query 106 to determine non-public types or other software constructs 108 within an executable code 102. In some cases, a programming environment may have services or special functions that may provide a simple mechanism for performing such queries. In other cases, the analysis engine 104 may be adapted to read the executable code 102, parse the various items within the executable code 102, and analyze the items to determine if the items are non-public or public.

When a non-public type or other software construct 108 may be discovered, the analysis engine 104 may create a public version of the item within the accessor executable code 110 along with a call to the non-public item within the executable code 102. In some cases, a function may be available for creating a direct call to a non-public item within the executable code 102. In other cases, the accessor executable code 110 may include complex series of peek and poke type commands that may exercise various non-public items within the executable code on a bit level.

In some cases, the accessor executable code 110 may include various logic or methods for making a call to a non-public item. The accessor executable code 110 may include a static call, where a single reference to a public version of a non-public item may call the item. In some cases, the accessor executable code 110 may include a dynamic call to a non-public item where the call may be defined with an unknown item that may be passed. In some embodiments, such an unknown item may be referred to as a generic item or variable.

When a static call is implemented, the analysis engine may be able to generate a relatively simple direct call to an item. In other cases, a call may be more complex. For example, a call to a non-public method may include references to several other non-public or public items. In such a case, a recursive process may be used to create public versions of the referenced non-public items to create a call to the original non-public method.

The test system 112 may use a combination of the accessor executable code 110 and calls to public items within the executable code 102 to exercise the executable code 102. In a typical test scenario, many and sometimes all of the non-public items within the executable code 102 may be exercised to determine if the executable code 102 is properly functioning. In other uses, selected non-public software constructs within the executable code 102 may be exposed through the accessor executable code 110.

The test system 112 may access non-public software constructs within the executable code 102 by calling a public version of the item in the accessor executable code 110 that calls the non-public types 114 and receives a return 116. The test system 112 may also call public types 118 and receive a return 120 from the executable code 102.

In some embodiments, the accessor executable code 110 may include calls to public items so that the test system 112 may interface the executable code 102 through the accessor executable code 110 for any software construct, public or non-public.

Some or all of the various components within embodiment 100 may operate within a runtime environment 122. The runtime environment 122 may be a virtual machine or other virtualization or simulation environment where code may be developed, debugged, tested, and sometimes deployed. In some embodiments, the runtime environment 122 may be a development tool or platform that is used for code development but where the executable code 102 may be intended to be operated on a different platform or system. An example of such an embodiment may be for firmware or other embedded code applications.

In some cases, the analysis engine 104 may operate outside the runtime environment 122 to parse and analyze the executable code 102 and create the accessor executable code 110 that may be subsequently compiled, interpreted, or otherwise used within the runtime environment 122. In some cases, the analysis engine 104 may operate within the runtime environment 122.

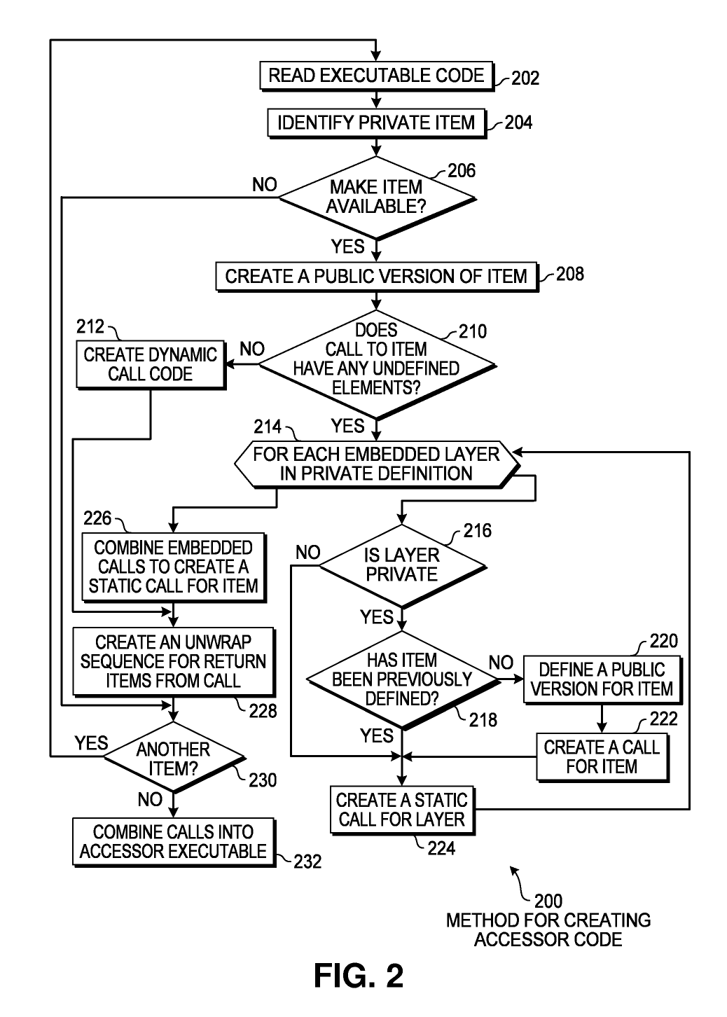

FIG. 2 is a flowchart illustration of an embodiment 200 showing a method for creating accessor executable code. Embodiment 200 may analyze a non-public item within an executable code and may create a call into the item. The item may have a static call or a dynamic call. In the case of a static call, the call may be created by recursively analyzing the various items in the call and creating a public version of any non-public items within the call.

Embodiment 200 is an example of a method that may be used to create any type of software construct for accessing a private software construct. For illustration purposes, embodiment 200 illustrates the creation of a public call that may be used to access a private call within an executable code. Variations of embodiment 200 may be used to create a public version of any type of private software construct, including methods, functions, classes, declarations, definitions, arguments, variables, references, or other software constructs.

The executable code is read in block 202. In some cases, the executable code may be read in a compiled or binary form. In other embodiments, the executable code may be read in an intermediate or bytecode form.

Within the executable code, a non-public item may be identified in block 204 and a decision may be made in block 206 to make the item available or public. The item may be any type of non-public variable, class, type, interface, object, method, function, or any other item that is not shared outside of the executable code.

In some embodiments, various decision criteria may be used to determine if a particular item is to be made public in block 206. In some cases, every non-public item may be made accessible. An example of such a case may be a test situation where every variable, function, method, class, interface, or object may be exercised to ensure the executable code functions as expected. In other cases, a particular type or name of an item may be used as criteria for making the item public.

A user interface may be used to select the non-public items from the executable code under test in block 206. In such a case, a user may be presented with a dialog box or other input device so that a user may select which items are to be made public. In other embodiments, a predetermined set of criteria may be created for automated operation. Many different types of mechanisms and criteria may be used to determine if an item is to be made public or not.

If an item is not to be made available or public in block 206, the process jumps to block 230.

If an item is to be made public in block 206, a public version may be created in block 208 to represent the item. The following portions of the embodiment 200 may create calls to the non-public items of the executable code under test.

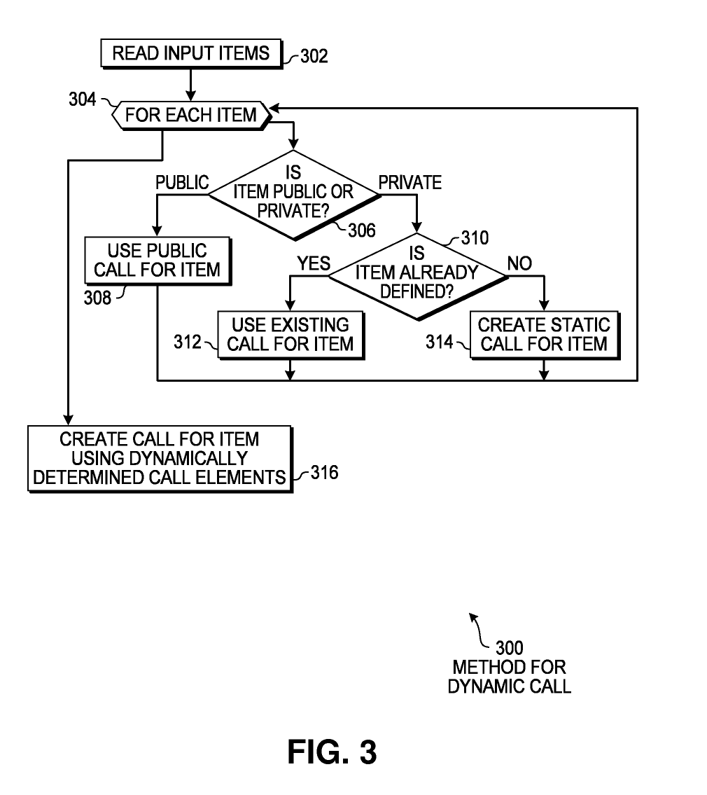

If a call to the item may have undefined elements in block 210, a dynamic call code may be created in block 212. The code created in block 212 may create a call to the non-public item at runtime, based on the variables, objects, or other items that are passed to the non-public item. A more detailed example of such dynamic calls may be found in the discussion of FIG. 3.

Some calls may have multiple layers of items, each of which may be a public or non-public item. For each embedded layer within a non-public definition in block 214, a recursive process may be invoked. If the layer is non-public in block 216 and the item has been previously defined in block 218, a status call for the layer may be created in block 224. Similarly, if the layer is public in block 216, a static call for the layer may be defined in block 224.

In an object oriented programming language, an example of a layer may be a method that is part of a class. Another example of a layer may be a variable that is passed to a function or method, where the variable is either a public or non-public variable. Such an example may be found in both object oriented and procedurally based programming languages.

If the item has not been previously defined in block 218, a public version may be defined for the item in block 220 and a call may be created for the item in block 222. In some embodiments, the block 220 may execute a recursive process similar to the process starting at block 208 for the newly identified non-public item. In some cases, multiple recursive processes may be created to handle a complex call.

After creating a static call for each of the various layers in block 224, a static call for the original non-public item may be created in block 226 by combining the various calls to the various layers.

In some cases, the static call for an item may include direct calls into a non-public variable, method, function, or other item. In other cases, a call may include more complex functions, such as a non-public interface in object oriented languages. Non-public interfaces may not be instantiated by a separate public version, so a separate object may be created to perform the functions of the non-public interface. The separate object may include methods that forward calls to the non-public methods defined in the non-public interface. Calls to or returns from the public version of an object that calls the interface may be routed through the separate object to implement the functionality of the non-public interface.

In some cases, an unwrap sequence may be constructed in block 228 to handle return variables and perform any conversion, translation, or processing that may be correlate a public version of an item with a non-public version.

If another item is to be processed in block 230, the process may continue in block 202, otherwise the various calls may be combined into an accessor executable file in block 232.

The accessor executable file may be created using source code and compiled into an executable code. In other embodiments, the accessor executable code may be created directly as an executable code without compiling.

A simple example will be discussed in an object oriented language. In the example, the executable code under test may have a function of the form:

internal class Employee{
internal void RaiseSalary(Reason[ ][ ] reasons){ }
}

The class Employee and the associated function RaiseSalary are internal or non-public functions to the code under test. Likewise, Reason[] [] may be a two dimensional array that is also non-public. An assessor executable code may include a call such as:

public class Employee_Accessor{
public void RaiseSalary(Reason_Accessor[ ][ ] reasons){ }
}

The accessor code may include a definition for a class Employee_Accessor and the method Employee_Accessor.RaiseSalary underneath the class. The accessor code for Employee_Accessor.RaiseSalary may include a call to the non-public method Employee.RaiseSalary.

In the definition of Employee_Accessor.RaiseSalary, there is a reference to Reason_Accessor[] [], which may be a public variable that may be linked to the non-public variable Reason[][]. When the definition of Employee_Accessor.RaiseSalary is created, a second layer of recursion may be used to define and insert the call to Reason_Accessor[] [].

FIG. 3 is a flowchart illustration of an embodiment 300 showing a method for performing a dynamic call. Embodiment 300 illustrates an example of the functionality that may be present in an accessor executable file to create a call into an executable code when the parameters of the call are not defined at compile time. Embodiment 300 builds a call for a non-public item by analyzing the input parameters for a call and building a call for the item.

Embodiment 300 is an example of a method that may be used to dynamically create any type of software construct for accessing a private software construct. For illustration purposes, embodiment 300 illustrates the creation of a public call for an item that may be used to access a private call for an item within an executable code. Variations of embodiment 300 may be used to dynamically create a public version of any type of private software construct, including methods, functions, classes, declarations, definitions, arguments, variables, references, or other software constructs.

Input items are read in block 302. For each input item in block 304, if the item is public in block 302, a public call for the item may be used in block 308. If the item is non-public in block 306 and is already defined in block 310, the existing call for an item may be used in block 312. If the item is not already defined, a static call for the item may be created in block 314.

The call for the item may be created in block 316 by combining the various call elements.

When a non-public item has not already been defined in block 310, a static call for the item may be created by analyzing the executable code and determining a static call using some of the steps illustrated in embodiment 200. In some cases, constructing such a call may involve recursively analyzing embedded references to other non-public items.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
reading a first executable file;
identifying a first non-public software construct within said first executable file;
creating a first public software construct comprising a first reference to said first non-public software construct; and
storing said first public software construct in a second executable file.

2. The method of claim 1, said first executable file being a binary file.

3. The method of claim 1, said first executable file comprising intermediate code.

4. The method of claim 1, said first software construct having at least one reference to a second non-public software construct.

5. The method of claim 4 further comprising:
creating a second public software construct comprising a second reference to said second non-public software construct said second software construct being incorporated into said first software construct.

6. The method of claim 5, said second reference being incorporated into said first software construct at runtime.

7. The method of claim 5, said second software construct being incorporated into said first software construct and storing said second software construct in said second executable file.

8. The method of claim 5, said second reference being defined at runtime.

9. A computer readable medium comprising computer executable instructions adapted to perform the method of claim 1.

10. A system comprising:
an analyzer adapted to:
read a first executable file;
identify a first non-public software construct within said first executable file;
create a first public software construct comprising a first reference to said first non-public software construct; and
store said first public software construct in a second executable file;
a runtime environment adapted to:
receive a runtime software construct from said second executable file, said runtime software construct comprising a reference to said first non-public software construct; and
perform said first non-public software construct.

11. The system of claim 10, said first software construct having at least one reference to a second non-public software construct.

12. The system of claim 11, said analyzer being further adapted to:
create a second public software construct comprising a second reference to said second non-public software construct, said second reference being incorporated into said first software construct.

13. The system of claim 12, said second software construct being incorporated into said first software construct at runtime.

14. The system of claim 12, said second software construct being incorporated into said first software construct and storing said second software construct in said second executable file.

15. The system of claim 12, said second software construct being defined at runtime.

16. A method comprising:
identifying a first executable file;
analyzing said first executable file to find a first non-public software construct within said first executable file;
creating a second executable file comprising:
a first public software construct; and
a first reference to said first non-public software construct within said first executable file; and
performing said first non-public software construct.

17. The method of claim 16, said first software construct having at least one reference to a second non-public software construct.

18. The method of claim 17 further comprising:
creating a second public software construct comprising a second reference to said second non-public software construct, said second reference being incorporated into said first software construct.

19. The method of claim 18, said second reference being incorporated into said first software construct at runtime.

20. A computer readable medium comprising computer executable instructions adapted to perform the method of claim 16.
